(19) United States
(12) Patent Application Publication
(10) Pub. No.: US 2022/0339817 A1
(43) Pub. Date: Oct. 27, 2022

(54) INTEGRATED MIXER AND NOZZLE DEVICE FOR 3D PRINTER OF BUILDING CONSTRUCTION AND METHODS FOR OPERATING THE SAME

(71) Applicants: Hisys Co., Ltd., Gimpo (KR); Black Buffalo 3D Corporation, New York, NY (US)

(72) Inventor: CHULHYUN JOO, Bucheon-si (KR)

(21) Appl. No.: 17/730,097

(22) Filed: Apr. 26, 2022

Related U.S. Application Data
(60) Provisional application No. 63/180,629, filed on Apr. 27, 2021.

(51) Int. Cl. B28C 5/12; B28B 1/00; B33Y 10/00; B33Y 30/00; B33Y 50/02; B28C 5/40; B28C 5/14; B28C 7/00; B28C 5/08

(52) U.S. Cl. CPC B28C 5/1253; B28B 1/001; B33Y 10/00; B33Y 30/00; B33Y 50/02; B28C 5/402; B28C 5/14; B28C 7/0046; B28C 5/0831

(57) ABSTRACT

an integrated mixer and nozzle device for a 3D printer of building construction components includes: a support; a mixer disposed inside the support to mix a first material and a second material together to produce a flowable mixture; a conveyor directly connected to the mixer to convey the flowable mixture in a first direction; and a nozzle directly connected to the conveyor to extrude the flowable mixture and to discharge the extruded mixture in a second direction different from the first direction.

### CROSS-REFERENCE TO RELATED APPLICATION

This application claims priority from and the benefit of U.S. Provisional Patent Application No. 63/180,629, filed on Apr. 27, 2021, which is hereby incorporated by reference for all purposes as if fully set forth herein.

### BACKGROUND

### Field

Embodiments of the invention relate generally to 3D printers for the construction industry and, more particularly, to integrated mixer and nozzle devices for use in 3D printer of building construction and methods for operating the same.

### Discussion of the Background

In general, reinforced concrete structures have high compressive strength and are widely used as structures such as the walls of buildings. However, according to this conventional method of constructing a reinforced concrete structure, the formwork must be installed, and after the concrete has cured, the formwork must be dismantled one by one. Accordingly, there is a disadvantage in that the number of processes is large, and as a result, the construction time period and cost are large.

On the other hand, recently, 3D printing manufacturing technology for molding a product of a three-dimensional shape through printing has been in the spotlight, and attempts are being made to manufacture a concrete structure using 3D printing to solve the above-mentioned conventional problems. For example, the generally known 3D printing method for concrete is to improve lamination by simply using a concrete mix with a low water-cement ratio (W/C), and attempts to produce and automate an atypical concrete have been made.

Accordingly, conventional 3D printer systems for construction adopted a wet method in which the mortar was transferred to a pump after stirring through a mixer located outside of the printing machine and concrete was sprayed through the nozzle part of the printing machine by a hose.

The above information disclosed in this Background section is only for understanding of the background of the inventive concepts, and, therefore, it may contain information that does not constitute prior art.

### SUMMARY

Applicant recognized that use of low W/C of concrete in #D printers for building construction, creates other problems such as lowered workability and extrudability of the concrete. Although the cement ratio can be increased, such a concrete mixture cannot be supplied smoothly from the nozzle part due to the high viscosity of the cement, and the nozzle hole may eventually and regularly become clogged.

Applicant also realized that conventional 3D printer systems for building construction may have decreased workability due to clogging of a hose connected between a conventional mixer and nozzle depending on the specific mixing conditions.

Integrated Mixer and nozzle devices for 3D printer of building construction constructed according to the principles and implementations of the invention and methods for operating the same provide better workability and extrudability than conventional systems. For example, they are capable of avoiding hose clogging issue by including a mixer integrate inside the 3D printer with a nozzle without a hose connection, e.g., at the bottom of the mixer.

Additional features of the inventive concepts will be set forth in the description which follows, and in part will be apparent from the description, or may be learned by practice of the inventive concepts.

According to one aspect of the invention, an integrated mixer and nozzle device for a 3D printer of building construction components includes: a support; a mixer disposed inside the support to mix a first material and a second material together to produce a flowable mixture; a conveyor directly connected to the mixer to convey the flowable mixture in a first direction; and a nozzle directly connected to the conveyor to extrude the flowable mixture and to discharge the extruded mixture in a second direction different from the first direction.

The conveyor may be directly connected to the mixer and the nozzle may be directly connected to the conveyor without any flexible conduits.

At least one of the following conditions may apply: 1) the support may include a support frame, ii) the mixer may include a mixing assembly, iii) the conveyor may include a conveyor assembly, and iv) the nozzle may include a nozzle assembly.

The mixer may include a mixing assembly including: a first receiving body including a blade having a first rotatable shaft projecting into an inner space in the first direction and a plurality of shakers arranged at predetermined intervals on the outer surface of the first rotatable shaft; a first material inlet and a second material inlet located on the first surface of the first receiving body; a first outlet located on the second surface of the first receiving body; a first supporter supporting the first receiving body and coupled to the support, and at least one load cell positioned at the lower end of the corners of the first supporter to sense a weight of the first material input into the first receiving body.

The mixing assembly may further include: a first driving motor located on a side of the first receiving body, and a first connecting shaft connecting the first driving motor and the blade.

The conveyor may include a conveying assembly including: a second receiving s body to receive the flowable mixture discharged from the mixer; a conveyor unit to convey the flowable mixture input into the second receiving body in the first direction; a second outlet located under one end of the second receiving body to discharge the conveyed mixture; a second driving motor to drive the conveyor unit, and a second connecting shaft connecting the second driving motor and the conveying unit.

The conveying unit may include a second rotating shaft projecting into the second receiving body in the first direction and a first screw flight helically formed on an outer surface of the second rotating shaft.

The nozzle may include a nozzle assembly comprising: a container to receive the mixture discharged from the conveyor, an extruder located in the container and to extrude the mixture in the second direction, and an outlet located at the lower end of the container to discharge the extruded mixture.

The nozzle assembly may further include: a supporter to support the container, a driving motor positioned above the container and attached to the supporter, a bevel gear unit to convert a direction of a rotational driving force of the driving motor and to transmit the driving force to the extruder, and a bearing unit located at the lower end of the bevel gear unit.

The extruder may include a extruding unit may including a rotatable shaft projecting into the container in the second direction and a second screw flight helically formed on an outer surface of the rotatable shaft.

The bevel gear unit may includes a first bevel gear coupled to a rotation shaft of the third driving motor and a second bevel gear coupled to the rotatable shaft of the extruding unit.

The bearing unit may include a first bearing and a second bearing, and at least one of the first and second bearings is a tapered bearing.

According to another aspect of the invention, a method for mixing and extruding material from an integrated device having a mixer, conveyor, and nozzle directly connected together without any flexible conduits to form building components from 3D printer, the method includes the steps of: driving a first motor to operate the mixere; driving a second motor in reverse direction to operate a conveyor; inputting a first dry material into the mixer; determining whether the first dry material has a weight greater than or equal to a preset reference value; stopping the flow of the first dry material once it reaches the preset reference value; inputting a second material into the mixer; and mixing the first dry material and the second material in the mixer to produce a flowable mixture.

The first dry material may include a mortar in which cement, sand, fiber, and an admixture are mixed, and the second material may be water.

The method may further include: discharging the flowable mixer; driving the second motor in a forward direction to operate the conveyor; and conveying the flowable mixture discharged from the mixer in a first direction in the conveyor.

The method may further include: adjusting the conveying speed of the flowable mixture according to the amount of the flowable mixture transferred from the mixer.

When the amount of the flowable mixture exceeds a predetermined reference value, the conveying speed may be reduced or stopped for a certain period of time.

The method may further include: discharging the flowable mixture conveyed by the conveyor; and driving a third motor to operate the nozzle.

The method may further include: extruding the mixture discharged from the conveyor in a second direction different from the first direction; and discharging the extruded mixture from the nozzle to form a building construction material layer.

The method may further include: adjusting the discharging speed of the extruded mixture based upon the width of the building construction material layer to be formed. A first discharging speed may correspond to a first width of the building construction material layer, and a second discharging speed higher than the first discharging speed may correspond to a second width of the building construction material layer wider than the first width.

It is to be understood that both the foregoing general description and the following detailed description are exemplary and explanatory and are intended to provide further explanation of the invention as claimed.

### is BRIEF DESCRIPTION OF THE DRAWINGS

The accompanying drawings, which are included to provide a further understanding of the invention and are incorporated in and constitute a part of this specification, illustrate illustrative embodiments of the invention, and together with the description serve to explain the inventive concepts.

FIG. 1 is a schematic cross-sectional view of an embodiment of an integrated mixer and nozzle device for a 3D printer of building construction constructed according to the principles of the invention.

FIG. 2A is a cross-sectional view of an embodiment of a mixing assembly included in the integrated mixer and nozzle device of FIG. 1.

FIG. 2B is a perspective view of the mixing assembly of FIG. 2B.

FIG. 3A is a side view of an embodiment of a conveyer assembly included in the integrated mixer and nozzle device of FIG. 1.

FIG. 3B is a perspective view of the conveyer assembly of FIG. 3A.

FIG. 4A is a front view of an embodiment of a nozzle assembly included in the integrated mixer and integrated nozzle device of FIG. 1.

FIG. 4B is a cross-sectional view of the nozzle assembly of FIG. 4A.

FIG. 4C is a perspective view of an embodiment of the nozzle assembly of FIG. 4A.

FIG. 5 is a flow chart of an embodiment of a method of operating an integrated mixer and nozzle device for a 3D printer of building construction according to the principles of the invention.

FIG. 6 is a flow chart of another embodiment of a method of operating an integrated mixer and nozzle device for a 3D printer of building construction according to the principles of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or flowable connection, with or without intervening elements. Further, the D1-axis, the D2-axis, and the D3-axis are not limited to three axes of a rectangular coordinate system, such as the x, y, and z — axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

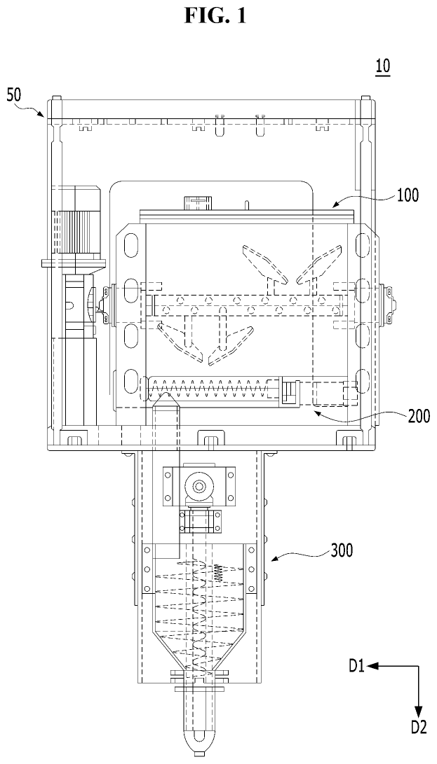

FIG. 1 is a schematic cross-sectional view of an embodiment of an integrated mixer and nozzle device for a 3D printer of building construction constructed according to the principles of the invention.

Referring to FIG. 1, the integrated mixer and nozzle device 10 includes a support, which may be in the form of support frame 50, a mixer, which may be in the form of a mixing assembly 100 disposed inside the support frame 50 and configured to mix first material and second materials which are input into the device 10 to produce a flowable mixture, a conveyor, which may be in the form of a conveying assembly 200 directly connected to the mixing assembly by being positioned under the mixing assembly 100 and configured to convey the flowable mixture in a first direction D1, and a nozzle, which may be in the form of a nozzle assembly 300 directly connected to the conveying assembly and configured to extrude the flowable mixture conveyed by the conveying assembly 200 and to discharge an extruded mixture in a second direction D2 different from the first direction D1, such as substantially perpendicular. The extruded mixture which is discharged from the nozzle assembly 300 may be used to form a construction material layer (e.g., concrete layer).

The support frame 50 may accommodate and/or support at least one of the mixing assembly 100, the conveying assembly 200, and the nozzle assembly 300. For example, referring to FIG. 1, the support frame 50 may have a box-type shape to accommodate the mixing assembly 100 and the conveying assembly 200 therein, and fix and support the nozzle assembly 300 at the lower portion. However, the inventive concepts are not limited thereto, and in some embodiments, the support frame 50 may have various shapes, such as a cylindrical shape, or configurations to support the various components.

The mixing assembly 100 may mix a first material and a second material which are input into the device 10. The first material may be a dry material. For example, the first material may be a mortar in which cement, sand, fiber, and an admixture are mixed. The second material may be water. In an embodiment, the mixing assembly 100 may not receive a flowable material (e.g., mixture of the mortar and water) but receive a dry material and water, separately, and then the dry material and the water are mixed in the mixing assembly 100, that is, a concrete agitation is performed in the mixing assembly 100. After a preset time has elapsed, the flowable mixture of mortar and water (e.g., concrete) may be discharged through a first outlet of the mixing assembly 100.

Accordingly, the workability and work efficiency may be improved by changing the input material, from wet materials (e.g., flowable concrete mix) having high viscous properties to dry materials (e.g., cement or mortar) for 3D printing construction components. Therefore, the overall construction period can be shortened by shortening the working time by supplying dry materials instead of supplying wet materials.

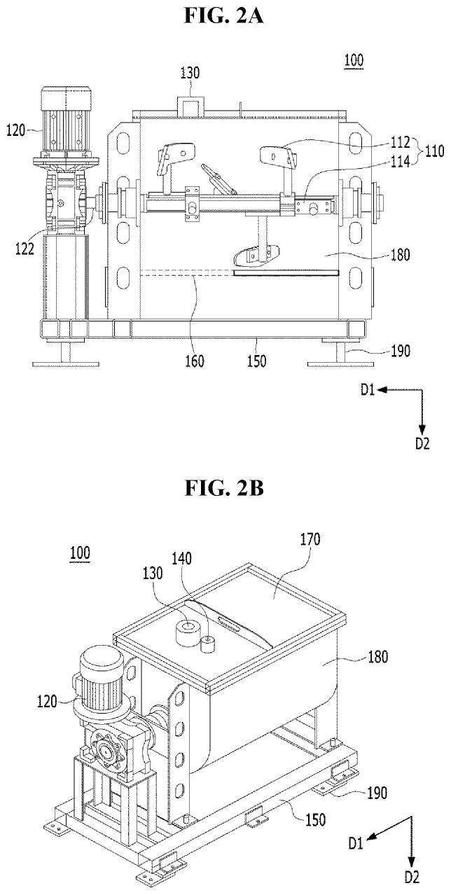

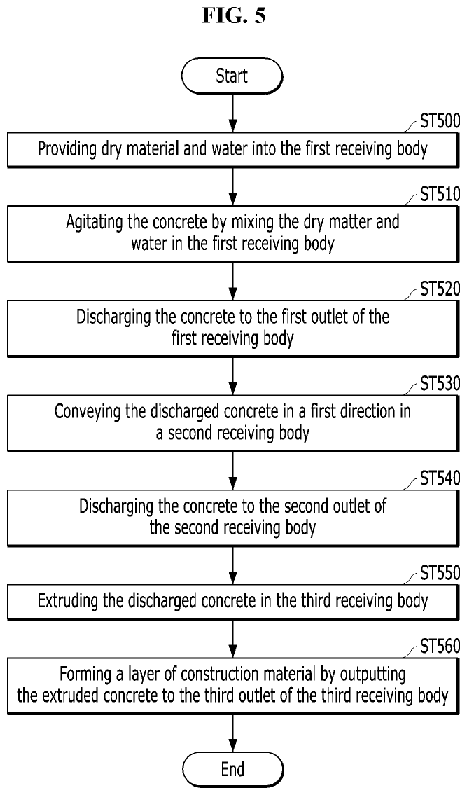

Further, in an embodiment, to clean a mixing blade part included in the mixing assembly 100, only water may be input into the mixing assembly 100 without inputting the dry material. Accordingly, the mixing assembly can be cleaned periodically during a working period through a water supply line connected to the mixing assembly to extend the life and maintenance of the integrated mixer and nozzle device. Hereinafter, the configuration and operation of the mixing assembly 100 will be described in more detail with reference to FIGS. 2A, 2B and 5.

The conveying assembly 200 may convey the mixture of mortar and water (e.g., flowable concrete) that has been mixed in the mixing assembly 100 to the nozzle assembly 300. That is, the conveying assembly 200 may receive the flowable mixture from the mixing assembly 100 and convey them in the first direction D1 to discharge the flowable mixture through a second outlet of the conveying assembly 200.

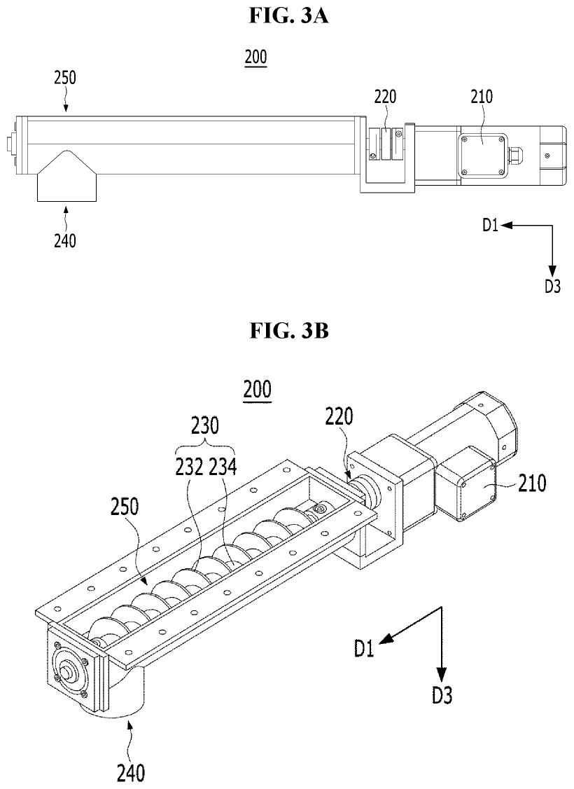

In an embodiment, the conveying assembly 200 may adjust the conveying speed according to the amount of the flowable mixture transferred from the mixing assembly 100. For example, when the amount of the flowable mixture exceeds a predetermined reference value, the speed may be reduced or stopped for a certain period of time. Hereinafter, the configuration and operation of the conveying assembly 200 will be described in more detail with reference to FIGS. 3A, 3B and 5.

The nozzle assembly 300 may extrude the flowable mixture transferred from the conveying assembly 200 and discharge an extruded mixture in a second direction D2 to form a construction material layer (e.g., a concrete layer). In this case, the second direction D2 may be the same as the direction discharged from the second outlet of the conveying assembly 200, and for example, it may be a downward direction as shown in FIG. 1.

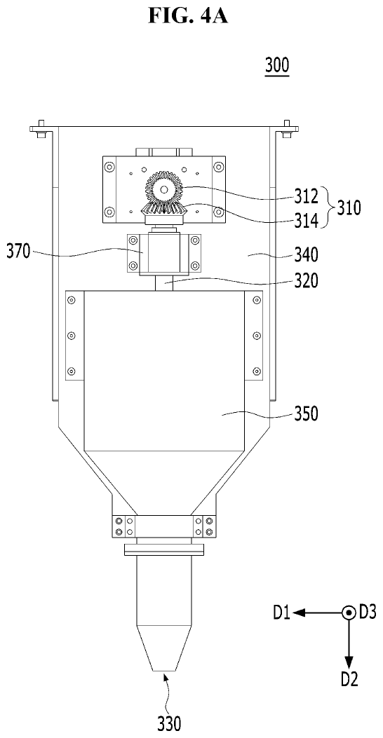

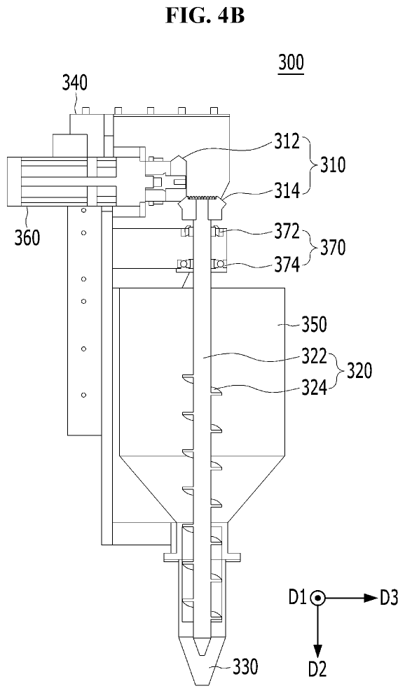

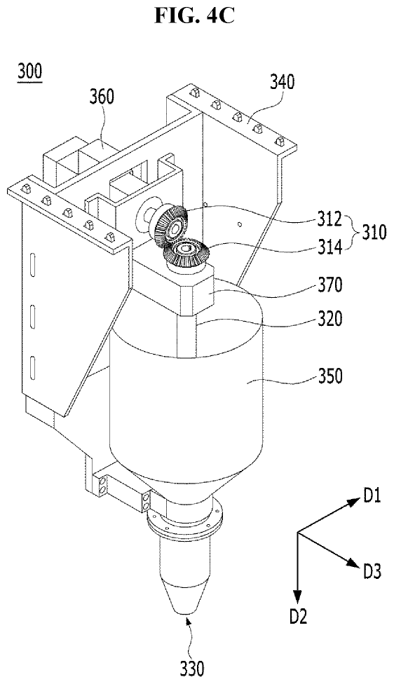

In an embodiment, the discharging speed of the extruded mixture from the nozzle assembly 300 may be adjusted according to the width of the construction material layer to be formed. For example, when the discharge speed is high, the construction material layer may have a wide width, otherwise when the discharge rate is low, the construction material layer may have a narrow width. Hereinafter, the configuration and operation of the nozzle assembly 300 will be described in more detail with reference to FIGS. 4A to 4C and FIG. 5.

FIG. 2A is a cross-sectional view of an embodiment of a mixing assembly included in the integrated mixer and nozzle device of FIG. 1, and FIG. 2B is a perspective view of an embodiment of a mixing assembly included in the integrated mixer and nozzle device of FIG. 1. Also, FIG. 5 is a flow chart of an embodiment of a method of operating an integrated mixer and nozzle device for a 3D printer of building construction according to the principles of the invention.

Referring to FIGS. 2A and 2B, the mixing assembly 100 includes a first receiving body 180, a first material inlet 130 and a second material inlet 140 located on the first surface of the first receiving body, which may be in the form of a first container 180, a first outlet 160 located on the second surface of the first receiving body, a first supporter, which may be in the form of a first support bracket 150 supporting the first receiving body and coupled to the support frame 50, and at least one load cell 170 located under the first support bracket 150.

The first container 180 may have an interior volume into which the first material and the second material are input and mixed. The first surface (e.g., upper surface) of the first container 180 may be covered by a cover 170, to prevent materials other than the first and second materials from being introduced into the first container 180.

In addition, a first outlet 160 may be located on a second surface (e.g., bottom surface) of the first container 180 to discharge the mixture of the first and second materials input through the first and second material inlets 130 and 140. The first container 180 may be coupled and supported by the first support bracket 150 which may be coupled to an inner surface of the support frame 50. The at least one load cell 190 may be positioned at the lower end of the corners of the first support bracket 150 as shown FIGS. 2A and 2B, and may sense the weight of the first material input into the first container 180.

The first material inlet 130 may be a dry material inlet, through which a dry material may be introduced. For example, the first material may be a mortar in which cement, sand, fiber, and an admixture are mixed. Also, as mentioned above, the load cell 190 can sense the weight of the first material input into the first container 180, and when the weight of the first material input reaches a preset reference value, the input of the first material may be stopped. For example, the preset reference value may be about 200 kg.

The second material inlet 140 may be a water inlet and may be connected to a hose, so that a preset amount of water for mixing with the first material (e.g., input dry material) may be introduced. For example, when the introduction of the first material corresponding to the preset reference value is completed, water is supplied through the second material inlet, and then the first material and the second material are mixed.

The first container 180 includes a mixing blade unit 110 having a first rotating shaft 114 projecting into an inner space in the first direction D1 and a plurality of shakers, which may be in the form of shaking members 112 arranged at predetermined intervals on the outer surface of the first rotation shaft 114 to mix the first and second materials.

In addition, the mixing assembly 100 further includes a first driving motor 120 located on a side of the first container 180 and a first connecting shaft 122 connecting the first driving motor 120 and the mixing blade unit 110. More specifically, one side of the first connection shaft 122 is coupled to the rotor of the first driving motor 120, and the other side of the first connection shaft 122 is connected to the first rotation shaft 114 of the mixing blade unit 110 to transmit the power of the first driving motor 120 to the first rotation shaft 114. In this case, the first rotation shaft 114 and the first connection shaft 122 may be integrally formed.

For example, as shown in FIG. 2A, each of the shaking members 112 may be implemented as a plate made of a hard material in an arc shape or annular shape coupled to the outer periphery of the first rotation shaft 114. The shaking members 112 may be arranged at predetermined intervals, and plates of adjacent shaking members 112 may be alternately arranged. That is, when the first shaking member is attached to the upper surface of the outer periphery of the first rotation shaft 114, the second shaking member adjacent thereto may be attached to the lower surface of the outer periphery of the first rotation shaft 114 rotated by 180 degrees.

The operation of the mixing assembly 100 will be described with reference to FIGS. 2A, 2B and 5.

First, a first material, for example, a dry mortar including cement, sand, fiber, and admixture is introduced through the first material inlet 130, and when the introduction of the first material corresponding to the preset reference value is completed, a preset amount of water is introduced through the second material inlet 140 (ST 500). In addition, when materials are introduced into the first and second material inlets 130 and 140, the first driving motor 120 may be driven to operate the mixing blade unit 110 to perform a mixing the materials including mortar and water (ST 510). More specifically, the first rotating shaft 114 of the mixing blade part 110 rotates by receiving the driving force transmitted through the first driving motor 120 and the first connecting shaft 122, and shaking members 112 also move according to the rotation of the first rotating shaft 114, and as the shaking members 112 move, concrete agitation is performed by mixing the mortar and water (ST 510). After a preset time elapses, when it is determined that the concrete agitation is complete, the mixture (flowable concrete) may be discharged in the second direction D2 through the first outlet 160 (ST 520).

Accordingly, the workability and work efficiency may be improved by changing input material, from wet materials (e.g., flowable concrete mix) having high viscous properties to dry materials (e.g., cement, mortar) for 3D printing of building construction components. Therefore, the overall construction period can be shortened by shortening the working time by supplying dry materials instead of supplying wet materials.

To clean a mixing blade part included in the mixing assembly 100, only water may be input into the mixing assembly 100 without inputting the dry material. Accordingly, the mixing assembly can be cleaned periodically during a working period through a water supply line connected to the mixing assembly to extend the life and maintenance of the mixer and integrated nozzle device.

FIG. 3A is a side view of an embodiment of a conveyer assembly included in the integrated mixer and nozzle device of FIG. 1, and FIG. 3B is a perspective view of an embodiment of the conveyer assembly of FIG. 3A.

Referring to FIGS. 3A and 3B, the conveying assembly 100 includes a second receiving body, which may be in the form of a second container 250 to receive the flowable mixture (flowable concrete) discharged from the first outlet 160 of the mixing assembly 100, a conveyor unit 230 to convey the flowable mixture input into the second container 250 in a first direction D1, a second outlet 240 located under one end of the second container 250 to discharge the conveyed mixture, and a second driving motor 210 to drive the conveyor unit 230.

As shown in FIG. 3B, an upper surface of the second container 250 has an opening corresponding to all area of the upper surface, and the opening may have substantially the same size as the first outlet 160 of the mixing assembly 100, thereby the upper surface of the second container 250 and the first outlet 160 can be coupled to each other. Accordingly, the mixture (concrete) discharged from the first outlet 160 can be introduced into the second container 250 of the conveying assembly 200 without loss.

In addition, the conveying assembly 200 including the second container 250 and the second driving motor 210 may be located in a space between the first container 180 and the first support bracket 150 of the mixing assembly 100 shown in FIGS. 2A and 2B, and the second driving motor may be fixed to the first support bracket 150.

The conveying unit 230 includes a second rotating shaft 234 projecting into the second container 250 in the first direction D1 and a first screw flight 232 helically formed on an outer surface of the second rotating shaft 234 to convey the mixture (concrete).

The conveying assembly 200 further includes a second connecting shaft 220 connecting the second driving motor 210 and the conveying unit 230. More specifically, one side of the second connection shaft 220 is coupled to the rotor of the second driving motor 210, and the other side of the second connection shaft 220 is connected to the second rotation shaft 234 of the conveying unit 230 to transmit power of the second driving motor 210 to the second rotating shaft 234. In this case, the second rotation shaft 234 and the second connection shaft 220 may be integrally formed.

The operation of the conveying assembly 200 according to the embodiment will be described with reference to FIGS. 2A, 2B and 5.

First, when the mixture is introduced through the opening of the second container 250, the second driving motor 210 is driven to operate the conveying unit 230 and convey the mixture in the first direction D1 (ST 530). More specifically, when the second rotating shaft 234 of the conveying unit 230 rotates with the driving force transmitted through the second driving motor 210 and the second connecting shaft 220, and the first screw flight 232 moves according to the rotation of the second rotating shaft 234, the mixture is conveyed in the first direction D1, and thus the conveyed mixture is discharged in the second direction D1 through the second outlet 240 located at the lower portion of one end of the second container 250 (ST 540).

In an embodiment, the conveying assembly 200 may adjust the conveying speed according to the amount of the flowable material discharged from the mixing assembly 100. For example, when the amount of the flowable mixture exceeds a predetermined reference value, the speed may be reduced or stopped for a certain period of time.

In addition, in order to clean the second rotating shaft 234 and the first screw plate 232, the second driving motor 210 may be reversely driven to rotate the second rotating shaft 234 in the opposite direction. For example, the reverse driving of the second driving motor 210 may be performed until the mixture is introduced into the second container 250.

FIG. 4A is a front view of an embodiment of a nozzle assembly included in the integrated mixer and nozzle device of FIG. 1, FIG. 4B is a cross-sectional view of an embodiment of the nozzle assembly of FIG. 4A, and FIG. 4C is a perspective view of an embodiment of the nozzle assembly of FIG. 4A.

Referring to FIGS. 4A to 4C, the nozzle assembly 300 includes a third receiving body, which may be in the form of a third container 350 to receive the mixture discharged from the conveying assembly 200, an extruding unit 320 located in the third container 350 and extruding the mixture in the second direction D2, and a third outlet 330 located at the lower end of the third container 350 to discharge the extruded mixture.

In addition, the nozzle assembly 300 further includes a second supporter, which may be in the form of a second support bracket 340 supporting the third container 350; a third driving motor 360 positioned above the third container 350 and attached to the second support bracket 340, and a bevel gear unit 310 to convert the direction of the rotational driving force of the third driving motor 360 and transmit the driving force to the extruding unit 320.

The second support bracket 340 may fix and support the third container 350, the third driving motor 360, and the bevel gear unit 310, which are components of the nozzle assembly 300, and may be coupled to a lower end of the support frame 50 shown in FIG. 1.

The extruding unit 320 includes a third rotating shaft 322 projecting into the third container 350 in the second direction D2 and a second screw flight 324 helically formed on an outer surface of the third rotating shaft 322 to extrude the mixture (concrete).

In addition, the nozzle assembly 300 includes the bevel gear unit 310 to convert the direction of the rotational driving force of the third driving motor 360 located on the upper side of the third container 350 and to transmit the driving force to the extruding unit 320. More specifically, the first bevel gear 312 of the bevel gear unit 310 is coupled to a rotation shaft of the third driving motor 360, and the second bevel gear 314 of the bevel gear unit 310 is coupled to the third rotation shaft 322 of the extruding unit 320. As shown in FIGS. 4A, 4B, an 4C, the rotation shaft of the third driving motor 360 extends in a third direction D3, and the third rotation shaft 322 extends in the second direction D2.

Further, the third rotation shaft 322 may be coupled to a bearing unit 370 located at the lower end of the second bevel gear 314. The bearing unit 370 may include a first bearing 372 and a second bearing 374, and at least one of the first and second bearings 372 and 374 may be a tapered bearing. Accordingly, referring to FIGS. 4A, 4B, 4C and 5, when the rotational force of the third driving motor 360 is transmitted to the extruding unit 320 by the bevel gear unit 310, the mixture introduced into the third container 350 is extruded in the second direction D2 (downward direction) by receiving a load in the downward direction by the tapered bearing unit 370 (ST 550). As such, the extruded mixture (concrete) is output through the third outlet 330, and the output mixture may form a construction material layer (concrete layer).

In an embodiment, the discharging speed of the extruded mixture from the nozzle assembly 300 may be adjusted according to the width of the construction material layer to be formed. For example, when the discharge speed is high, the construction material layer may have a wide width, otherwise when the discharge rate is low, the construction material layer may have a narrow width.

According to the principles and illustrative embodiments of the invention, as the properties of concrete can be maintained substantially constant, supplying and transporting characteristics of the concrete are stable, and clogging the pump equipment and failure of the entire system can be reduced or prevented altogether.

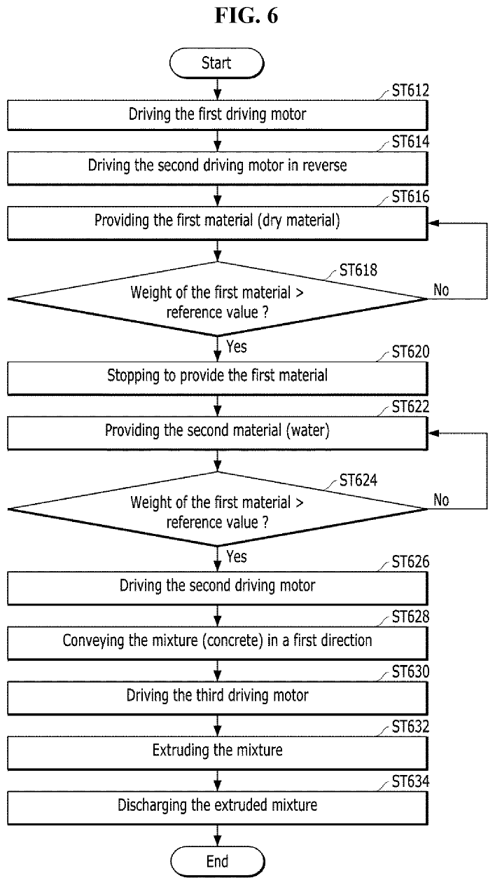

FIG. 6 is a flow chart of another embodiment of a method of operating an integrated mixer and nozzle device for a 3D printer of building construction according to the principles of the invention.

Referring to FIG. 6 and FIGS. 1 through 4C, when the first driving motor 120 of the mixing assembly 100 is driven, the operation of the mixer and integrated nozzle device 10 is started (ST 612).

Also, after the first driving motor 120 is started to be driven, the second driving motor 210 of the conveying assembly 200 starts to be driven in reverse (ST 614). As illustrated in FIGS. 3A and 3B, the second driving motor 210 may be reversely driven to rotate the second rotating shaft 234 in the opposite direction in order to clean the second rotating shaft 234 and the first screw plate 232. For example, the reverse driving of the second driving motor 210 may be performed after the first driving motor 120 is started to be driven until the mixture is introduced into the second container 250.

Next, the first material, for example, a dry mortar including cement, sand, fiber, and admixture is introduced through the first material inlet 130 into the first container 180 of the mixing assembly 100 (ST 616).

After providing the first material (i.e., dry material) into the first container 180, it is determined whether the weight of the first material input into the first container 180 is greater than or equal to the preset reference value (ST 618). For example, the load cell 190 located under the first support bracket 150 as shown in FIGS. 2A and 2B may sense the weight of the first material input into the first container 180, and when the weight of the first material input reaches a preset reference value, the input of the first material may be stopped (ST 620). Otherwise, the supply of the first material may continue until reaching the preset reference value. For example, the preset reference value may be about 200 kg.

Next, when the introduction of the first material corresponding to the preset reference value is completed, that is, when stopping to provide the first material, the second material (i.e., water) is supplied into the first container 180 (ST 622), thereby the first material and the second material are mixed by operating the mixing blade unit 110 according to the driving of the first driving motor 120.

After a preset time elapses, when it is determined that the concrete agitation is complete, the mixture (flowable concrete) may be discharged in the second direction D2 through the first outlet 160 (ST 624).

Next, the second driving motor 210 starts to be driven correctly without reversely being driven in order to operate the conveying assembly 200 (ST 626). Accordingly, as shown in FIGS. 3A and 3B, when the mixture is introduced through the opening of the second container 250, the second driving motor 210 is driven to operate the conveying unit 230 and convey the mixture in the first direction D1 (ST 628). Thus, the conveyed mixture is discharged in the second direction D1 through the second outlet 240 located at the lower portion of one end of the second container 250.

Next, the third driving motor 360 starts to be driven in order to operate the nozzle assembly 300 (ST 630). Accordingly, as shown in FIGS. 4A, 4B and 4C, when the rotational force of the third driving motor 360 is transmitted to the extruding unit 320 by the bevel gear unit 310, the mixture introduced into the third container 350 is extruded in the second direction D2 (downward direction) by receiving a load in the downward direction by the tapered bearing unit 370 (ST 632). As such, the extruded mixture (concrete) is discharged through the third outlet 330, and the output mixture may form a construction material layer (concrete layer) (ST 634).

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An integrated mixer and nozzle for a 3D printer of building construction components, the integrated device comprising:
a support;
a mixer disposed inside the support to mix a first material and a second material together to produce a flowable mixture;
a conveyor directly connected to the mixer to convey the flowable mixture in a first direction; and
a nozzle directly connected to the conveyor to extrude the flowable mixture and to discharge the extruded mixture in a second direction different from the first direction.

2. The device of claim 1, wherein the conveyor is directly connected to the mixer and the nozzle is directly connected to the conveyor without any flexible conduits.

3. The device of claim 1, wherein at least one of the following conditions applies:
i) the support comprises a support frame, ii) the mixer comprises a mixing assembly, iii0 the conveyor comprises a conveyor assembly and iv) the nozzle comprises a nozzle assembly.

4. The device of claim 1, wherein the mixer comprises a mixing assembly comprising:
a first receiving body including a blade having a first rotatable shaft projecting into an inner space in the first direction and a plurality of shakers arranged at predetermined intervals on the outer surface of the first rotatable shaft;
a first material inlet and a second material inlet located on the first surface of the first receiving body;
a first outlet located on the second surface of the first receiving body;
a first supporter supporting the first receiving body and coupled to the support, and
at least one load cell positioned at the lower end of the corners of the first supporter to sense a weight of the first material input into the first receiving body.

5. The device of claim 4, wherein the mixing assembly further comprises:
a first driving motor located on a side of the first receiving body, and
a first connecting shaft connecting the first driving motor and the blade.

6. The device of claim 1, wherein the conveyor comprises a conveying assembly comprising:
a second receiving body to receive the flowable mixture discharged from the mixer;
a conveyor unit to convey the flowable mixture input into the second receiving body in the first direction;
a second outlet located under one end of the second receiving body to discharge the conveyed mixture;
a second driving motor to drive the conveyor unit, and
a second connecting shaft connecting the second driving motor and the conveying unit.

7. The device of claim 6, wherein the conveying unit comprises a second rotating shaft projecting into the second receiving body in the first direction and a first screw flight helically formed on an outer surface of the second rotating shaft.

8. The device of claim 1 wherein the nozzle comprises a nozzle assembly comprising:
a container to receive the mixture discharged from the conveyor,
an extruder located in the container to extrude the mixture in the second direction, and
an outlet located at the lower end of the container to discharge the extruded mixture.

9. The device of claim 8, wherein the nozzle assembly further comprises:
a supporter to supporting the container,
a driving motor positioned above the container and attached to the supporter,
a bevel gear unit to convert a direction of a rotational driving force of the driving motor and to transmit the driving force to the extruder, and
a bearing unit located at the lower end of the bevel gear unit.

10. The device of claim 9, wherein the extruder comprises and extruding unit including a rotatable shaft projecting into the container in the second direction and a second screw flight helically formed on an outer surface of the rotatable shaft.

11. The device of claim 10, wherein the bevel gear unit comprises a first bevel gear coupled to a rotation shaft of the third driving motor and a second bevel gear coupled to the rotatable shaft of the extruding unit.

12. The device of claim 11, wherein the bearing unit comprises a first bearing and a second bearing, and at least one of the first and second bearings is a tapered bearing.

13. A method for mixing and extruding material from an integrated device having a mixer, a container, and a nozzle directly connected together without any flexible conduits to form building components from a 3D printer, the method comprising the steps of:
driving a first motor to operate the mixer;
driving a second motor in reverse direction to operate a conveyor;
inputting first dry material into the mixer;
determining whether the first dry material has a weight greater than or equal to a preset reference value;
stopping the flow of the first dry material once its reaches the preset reference value;
inputting a second material into the mixer; and
mixing the first dry material and the second material in the mixer to produce a flowable mixture.

14. The method of claim 13, wherein:
the first material comprises a mortar in which cement, sand, fiber, and an admixture are mixed, and
the second material comprises water.

15. The method of claim 13, further comprising the steps of:
discharging the flowable mixture from the mixer;
driving the second motor in a forward direction to operate the conveyor; and
conveying the flowable mixture discharged from the mixer in a first direction D1 in the conveyor.

16. The method of claim 15, further comprising the steps of:
adjusting the conveying speed of the flowable mixture according to the amount of the flowable mixture transferred from the mixer.

17. The method of claim 16, wherein when the amount of the flowable mixture exceeds a predetermined reference value, the conveying speed is reduced or stopped for a certain period of time.

18. The method of claim 15, further comprising the steps of:
discharging the flowable mixture conveyed by the conveyor; and
driving a third motor to operate the nozzle.

19. The method of claim 18, further comprising the steps of:
extruding the mixture discharged from the conveyor in a second direction different from the first direction; and
discharging the extruded mixture from the nozzle to form a building construction material layer.

20. The method of claim 19, further comprising the steps of:
adjusting the discharging speed of the extruded mixture based upon the width of the building construction material layer to be formed,
wherein a first discharging speed corresponds to a first width of the building construction material layer, and a second discharging speed higher than the first discharging speed corresponds to a second width of the building construction material layer wider than the first width.
